(19) United States
(12) Patent Application Publication
(10) Pub. No.: US 2010/0154417 A1
(43) Pub. Date: Jun. 24, 2010

(54) Hybrid Power Solar Facilities

(76) Inventors: Roger Ferguson, Des Moines, IA (US); Luke Shors, Somerville, MA (US); Kenneth Bryden, Ames, IA (US); Steve Corns, Rolla, MO (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 12/483,899

(22) Filed: Jun. 12, 2009

Related U.S. Application Data
(63) Continuation-in-part of application No. 12/394,272, filed on Feb. 27, 2009.
(60) Provisional application No. 61/061,189, filed on Jun. 13, 2008.

(51) Int. Cl. F03G 4/00; F03G 6/00; F03G 6/06

(52) U.S. Cl. 60/641.2; 60/641.8; 60/641.15

(57) ABSTRACT

A hybrid power plant is disclosed wherein a first power plant produces secondary steam of a first, relatively low temperature using a renewable source of energy such as geothermal or solar. The steam from the renewable source plant is passed through a solar power plant that has an operating temperature higher than that of the first temperature which results in superheating the first temperature steam to the higher temperature in the higher temperature solar power plant. Higher efficiencies are obtained.

### CROSS-REFERENCE TO RELATED APPLICATIONS

This application claims priority to U.S. Patent Application Ser. No. 61/061,189, filed Jun. 13, 2008, which is incorporated herein by this reference, and is a continuation-in-part of U.S. patent application Ser. No. 12/394,272, filed Feb. 27, 2009.

### BACKGROUND OF THE INVENTION

The invention relates generally to power plants and, more specifically, to hybrid power facilities combining solar or geothermal power generation facilities. This patent addresses benefits that can be achieved by using the higher operating temperature available in solar power plants with a lower energy source such as geothermal or lower energy solar facilities.

While there are several existing designs that combine different elements of renewable energy, none have taken advantage of the higher energy concentration of a central receiver solar facility with lower energy thermal sources of energy. This indicates that the combination of these renewable energy streams is unique. The work that has been published to date can be grouped into two categories: 1) methods for using fossil fuels to add energy to steam produced from renewable energy streams, and 2) combined cycles using gas turbine units and renewable energy power plants. Other designs falling in the general area of superheating steam produced from renewable sources are described below.

A design by Moore [1995] was patented that uses the thermal energy from a solar central receiver to heat molten salt. This salt is then passed through a furnace, where it is heated with either the exhaust of a gas turbine unit or by fossil fuel fired burners. This salt is then used to generate superheated steam to drive a steam turbine generator. While this design does incorporate central receiver technology, it differs from our design in that the fossil fuel adds heat to the working fluid.

Meksvanh et al. [1995] filed a patent for a design that routed heated water from a parabolic trough solar energy system underground to create an artificial geothermal reservoir. This is similar in only research area, but it is not related to the present design.

Other patents and research in this area are a combined cycle geothermal and fuel cell system described in the patent by Licari et al. [2006], which uses a combined cycle system with a fuel cell producing electricity and the waste heat of the fuel cell used in conjunction with a geothermal plant to increase the cycle efficiency. This is fundamentally different than the present design. Also, hybrid solar energy receivers as described in a patent by Mehos [2004] are namely hybrid solar receiver which can also utilize fossil fuel to increase the thermal output. This unit is mounted on a parabolic mirror, and can only be used for a sterling engine.

### SUMMARY OF THE INVENTION

The invention consists of a hybrid power plant that combines a variety of renewable heat sources to produce superheated steam. Saturated steam is generated by a lower energy renewable source, and then superheat is added to the steam by the working fluid of a solar facility. These lower energy renewable sources would include geothermal and low energy solar sources, such as parabolic trough thermal solar systems.

### BRIEF DESCRIPTION OF THE DRAWINGS

FIG. 1 is a schematic diagram of a hybrid geothermal-central receiver power plant.

FIG. 2 is a schematic diagram of a hybrid parabolic trough-central receiver power plant.

### DESCRIPTION OF THE INVENTION

The present invention relates to a hybrid power plant that combines a variety of renewable heat sources to increase the capacity and efficiency from stand alone plants. Saturated steam is generated by the lower energy renewable sources and then superheat would be added to the steam by the working fluid of the higher temperature renewable energy facility. These renewable sources include geothermal and thermal solar energy sources. A brief discussion of how these energy sources are utilized will be helpful when considering how to combine these energy sources with other existing methods.

### Geothermal

There are three forms of geothermal energy that could potentially be used in combination with other methods of energy production: (1) Hydrothermal—Steam generated in the Earth's crust; (2) Hot Dry Rock—Heated rock formations in the Earth's crust; and (3) Magma—Magmatic intrusions near the Earth's surface.

Currently, the majority of the geothermal energy being used to produce electricity is from the hydrothermal resources. This is done by tapping into existing steam/hot water contained in reservoirs in the rock. Hot dry rock resources are nearly identical except that there is no water trapped underground. Both of these methods are currently employed in the generation of electricity, although the requirements for hydrothermal limit the locations where it can be used. Magma energy takes advantage of molten rock located near the Earth's surface to create electricity.

Of these three technologies, hydrothermal and hot dry rock are the only methods practiced at this time. Drilling at the only proposed magma energy site was initiated in 1989 to test experimental apparatus for use in magma energy, but high costs and difficulty in reaching the required depths has prevented this test equipment from being implemented. Hydrothermal has the most installed capacity, with approximately 2 GW of electricity being generated from a Northern California site (The Geysers).

There are three methods for extracting energy from geothermal sources: dry steam systems, flash systems, and binary cycles. Dry steam systems operate by extracting underground steam and routing it through a steam turbine to generate electricity. The steam is then condensed and pumped back into the Earth through reinjection wells. This method requires the least amount of capital equipment, but also requires a geothermal source of steam, requiring a high concentration of geothermal energy. Most accessible sources of geothermal energy are lower energy sites (most hydrothermal and essentially all hot dry rock) that provide heated water rather than steam. To produce electrical energy from these sources requires that steam be produced through another mechanism. For the flash type system, the hot working fluid is passed into a lower pressure flash chamber, where the decreased pressure causes some of the hot water to flash to steam. This steam can then be used to drive a turbine, as in the dry steam system. Another method is to transfer the heat of the working fluid into a secondary fluid in a binary system. This type of system uses the hot geothermal fluid to boil a second working fluid that is then used to produce electricity. Using a closed system for the vapor power system makes it possible to use a working fluid with a lower flash point. This makes it possible to generate pressurized steam at much lower temperatures than if water were used.

Two of the main issues associated with geothermal power are the low operating temperature and the chemistry of the working fluids. The operating temperature for geothermal plants is dictated by the temperature of the rock formations that are providing the thermal energy. The hydrothermal plants rely on pre-existing steam flows to provide this energy, and so there is no investment necessary to supply the working fluid. Because of this, the steam temperature is limited to what occurs in nature, with a typical value of about 400° F., although some sources give values as high as 600° F. While there are many more locations where hot dry rock geothermal energy could be produced, these locations are limited by current technology's ability to penetrate the Earth's crust and to maintain clear and usable geothermal wells. These limitations prevent reliable access to thermal reservoirs buried deep in the Earth, making 350° F. a typical expected temperature from this resource.

Another issue with geothermal energy sources is the mineral content that the working fluid picks up as it is heated. Because the water is pumped underground and then collected to use the thermal energy, a large amount of minerals are absorbed into the fluid. This often leads to heavy fouling (a buildup of deposits that reduces heat transfer) of the power plant surfaces where the energy is transferred. There is also a possibility that the working fluid will become caustic, which reduces the power plant's life span and can be hazardous to operators.

### Solar

There are three forms of solar energy that could potentially be used in combination with other methods of energy production: (1) Central Receivers—Solar radiation concentrated on a receiving tower using minors (Heliostats); (2) Parabolic Troughs—Reflective troughs that concentrate solar energy on a pipe running through the focal point; and (3) Photovoltaics—Directly converts solar radiation to electricity on an atomic scale.

Other forms of solar energy are the parabolic dish and solar ponds. Parabolic dishes are similar to parabolic troughs, except that the energy is focused to a single point. This energy can be sufficient to operate a sterling engine, but currently there is no evident technology that can bring this technology to a large enough scale to be considered for use in a utility application. The temperatures achieved in a solar pond are typically 200° F. or lower, making the use of this technology impractical for large scale power production.

Photovoltaics are the most well known method to produce electricity from solar energy, however the cost to produce the solar cells, the hazardous waste stream that they produce when manufactured and low efficiency prohibits their use in commercial scale energy production.

Central receiver systems collect solar energy by using a field of heliostats to concentrate the energy on a tower placed in the center of the heliostat field. This concentration of energy is used to heat a molten salt in the tower, which is then circulated through a heat exchanger to boil a working fluid to drive a Rankine cycle. Typical values for these central receivers can be as high as 1100° F., yielding steam temperatures as high as 1050° F. However, no central receiver system has been constructed that has more than 15 MW of capacity.

Parabolic trough systems collect solar energy by reflecting and concentrating the sunlight on a pipe running through the centerline of the parabolic solar collectors. This concentrated sunlight heats oil that is being pumped through the pipe to a temperature as high as 735° F. This oil can then be used in a heat exchanger to boil water and add superheat to the steam produced.

While the thermal solar energy systems can achieve temperatures sufficient to drive high efficiency energy cycles, size limitations constrain the amount of energy that can be gathered at one site. Central receiver systems have been able to achieve steam temperatures comparable to those found in some smaller coal-fired power plants, but require a large footprint to produce a relatively small amount of energy. In addition, the heat transfer fluids used in these systems (molten salt, thermal oils, etc.) are either solids or very thick liquids at normal atmospheric temperatures. To keep these fluids in a usable state during shutdown periods or large transients requires an addition of heat, usually from fossil fuel powered sources.

### Literature Review

The initial step in this project was a literature review to investigate similar work that has been examined in the area and thereby establish the originality of this proposal. This literature review was composed of two areas: similar patents and scholarly papers in the area. While generating capacity exists for geothermal and solar energy systems, they are currently viewed as an emerging technology by the industry, and so there is limited information in industry publications describing existing designs and most documentation is found in scholarly journals.

There are several scholarly articles regarding hybrid power systems involving solar and/or geothermal energy. Some examples of these combinations are as follows: (a)

Solar and Geothermal (Lentz and Almanza, 2006)—This paper describes a hot dry rock geothermal power plant that is augmented using a solar field of parabolic troughs concentrators; (b) DiPippo, Kestin, and Khalifa (1978 and 1981)—These works describe the use of fossil fuels to add superheat to steam created from geothermal sources. While binary geothermal systems were not addressed, it was noted by the authors that the efficiency of geothermal systems was greatly improved through the use of coal powered superheaters; and (c) Bruhn (1999)—This paper describes the use of geothermal energy to add preheat to a fossil fuel powered steam turbine cycle. This was found to be beneficial in low energy geothermal fields, but this same benefit could be achieved using standard feed water heaters.

### Novel Hybrid Power Plants

Superheated Steam from Hybrid Power Facilities:

The primary focus of this research is to establish the viability of merging energy sources to increase the overall utility of both. This utility includes the cost of the facilities as well as overall plant efficiency and emission controls. While there are existing patents that are similar to our concepts, there are two novel design combinations proposed here that are advantageous: (a) Geothermal (hydrothermal and dry, hot rock) saturated steam with solar energy superheater and (b) Parabolic trough solar energy system for saturated steam with central receiver superheater.

### Geothermal-Solar Hybrid Plant

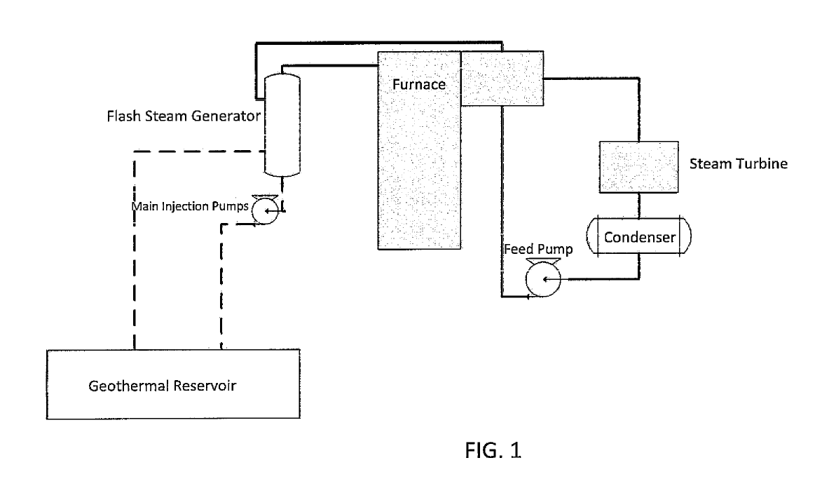

This patent combines a geothermal power plant with a higher energy solar power plant. Our example here is a central receiver power plant (FIG. 1), although any solar facility operating at a higher temperature than the geothermal source would apply. Steam is generated from any of the three types of geothermal sources; direct steam, flash steam or a boiler for binary geothermal systems. The steam produced by these methods is saturated steam, mainly due to the low thermal energy levels found in geothermal sources. This saturated steam is then passed through a heat exchanger where the steam is superheated by heat transferred by the working fluid of the solar system. The superheated steam is then passed through the turbine train. In the case of hydrothermal power plants, the steam could then be released to atmosphere or allowed to condense to supply water for any local needs. For hot, dry rock systems the steam would be condensed in the condenser and then pumped back into the earth to absorb more energy.

This design uses the energy from the geothermal source to boil the water and the energy from the solar system to add superheat to the steam. This takes advantage of the higher operating temperature of the solar plant to superheat the steam, making it possible to use a superheated steam turbine train. By using a turbine train designed for higher temperature steam, a higher efficiency can be achieved. It also makes it possible to use the more constant geothermal heat source to maintain sufficient heat for the solar system's working fluid during shutdown periods, making less fossil fuel necessary for the task.

### Solar Hybrid Plant

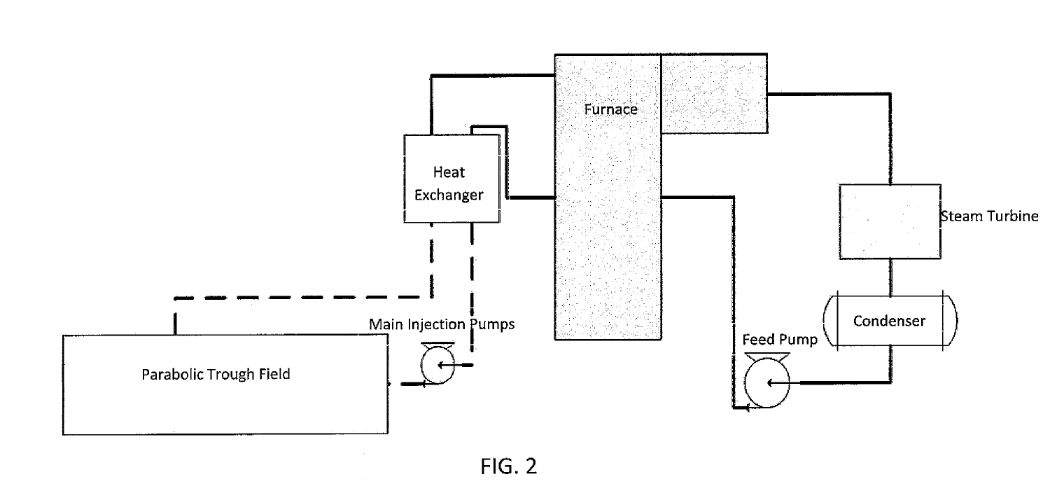

This patent combines two forms of solar energy to create a larger supply of superheated steam. Our example (FIG. 2) shows a central receiver solar plant with a parabolic trough solar plant, although any combination of relatively lower and higher energy solar facilities would be applicable. For this example, solar energy is collected in the parabolic trough field and directed to a heat exchanger, where the secondary working fluid is boiled to produce steam. This steam is then passed through another heat exchanger where the heat energy from the central receiver working fluid is used to superheat the steam. The superheated steam is then passed through the turbine train, condensed in the condenser and enters the feed pumps. The feed pumps then move the fluid back to the heat exchanger.

This design uses the energy from the lower energy system to boil the water and possibly add some superheat, with the remaining superheat added by a higher energy solar system. This takes advantage of the higher operating temperature to superheat the steam, making it possible to use a higher temperature steam turbine train. By using a turbine train designed for higher temperature steam, a higher efficiency can be achieved.

### Evaluation

The combinations of technologies in each of these proposed solutions create a facility that is advantageous to the stand alone technologies. In addition, none of the technologies discussed here requires fueling or is a contributor of greenhouse gases. The following discusses some of the benefits found in the given example hybrid facilities.

The combination of geothermal power and other technologies has a varying benefit depending mainly on the availability of geothermal power. This is due in large part because of the varying reports on the amount of geothermal energy available at a given source. For the analysis in this report, the assumption will be that a temperature of 600° F. can be reached using geothermal reservoirs. This allows for a large contribution from the geothermal source. Smaller geothermal energy sources would gain as much or more of a benefit from our design by the addition of more energy to the system.

### Geothermal-Central Receiver Hybrid Plant

Similar to the combination of geothermal and coal technology, this design replaces the coal plant with a central receiver solar plant. The contribution of the geothermal plant is the same as when it is combined with coal (1118 Btu/1 bm), with a contribution of 330 Btu/1 bm from the central receiver plant to superheat the steam. This gives a cost of about $0.094 per kW-hr, but there would be essentially zero carbon emissions. The increase in plant capacity would be about 50%. This type of facility seems to be a natural fit for a location such as Nevada, which has a large amount of desert areas and an ample supply of geothermal energy.

### Parabolic Trough-Central Receiver Hybrid Plant

Combining these two solar plants would increase the efficiency of the parabolic trough plant by using the high temperature central receiver technology. The water could be boiled and slightly superheated using the parabolic trough cooling fluid (contributing 1220 Btu/1 bm) and then add the remaining amount of superheat using the molten salt (contributing 229 Btu/1 bm.) This yields an electricity cost of about $0.111per kW-hr and a carbon reduction of essentially 100%.

### How Energy is Combined

For the previous descriptions, the systems were maintained as two distinctly different systems that act on the secondary working fluid (steam). It would also be possible to combine these technologies to act on the primary working fluid. For geothermal technologies, the hot ground water could be heated directly by the working fluid of a central receiver, provided the water was adequately pressurized to prevent it from flashing to steam. When combining geothermal or parabolic trough plants with a central receiver, it may also be possible to add heat to the central receiver working fluid using these sources.

### Capacity

The increased capacity of these power plants is important, in that most of the installed capacity is of a much smaller scale than traditional fossil fuel power plants. For the solar installations, this extra energy could be used to heat molten salt in a storage facility so that the plant could continue to produce electricity when there is no sun. This would remove one of the larger drawbacks to solar energy; it is only available when there is sunlight.

When applied to the geothermal power plants, there is a concern as to whether the geothermal reservoirs are truly renewable energy sources. Some fields have been “overworked” by removing too much energy, and it is theorized that these fields will be usable once energy has been allowed to build back up. By maintaining the initial capacity while removing less heat from the geothermal reservoir, we argue that we can make this a more renewable resource by not overworking and therefore depleting the wells.

Central receiver facilities are typically small scale (<15 MW). By combining this technology with other, larger facilities (the SEGS parabolic trough power plant is rated at about 100 MW), the central receivers may become more economically viable, and lowering the cost per kW-hr.

### Maintaining Solar Coolants:

One of the issues to be addressed in the use of solar energy is the amount of energy that needs to be maintained in the system to ensure that the primary heat transfer fluid remains in a usable state. By connecting a geothermal system to the solar unit the heat from the geothermal energy source could be used to help maintain the temperature levels necessary to prevent solidification of the molten salt for the central receiver or congealing of the thermal oils in the parabolic trough systems.

### REFERENCES

Bellac, A. and Destefanis, R. (2005) “Solar Power Enhanced Combustion Turbine Power Plants and Methods,” U.S. Pat. No. 6,941,759.
Bharathan, D., Bohn, M., and Williams, T. (1995) “Hybrid Solar Central Receiver for Combined Cycle Power Plant,” U.S. Pat. No. 5,417,052.
Blaize, L. (1994) “Hybrid Electric Power Generation,” U.S. Pat. No. 5,311,741.
DiPippio, R., Khalifa, H. E., Correia, R., and Kestin, J. (1978) “Fossil Superheating in Geothermal Steam Power Plants,” Department of Energy Report, Contract No. Ey-76-S-02-4051.A001.
DiPippio, R., DiPippio, E. A., Kestin, J., and Khalifa, H. E. (1981) “Compound Hybrid Geothermal-Fossil Power Plants,” Journal of Engineering for Power, 103 (4), pp. 797-804.
El-Wakil, M. M. (1984) Powerplant Technology, McGraw-Hill Inc., New York, N.Y.
Finckh, H. (1981) “Solar Power Plant with Open Gas Turbine Circuit,” U.S. Pat. No. 4,259,836.
Fisher, U. (2003) “Method and Apparatus for Producing Power,” U.S. Pat. No. 6,510,695.
Goldman, A. (2007) “Hybrid Generation with Alternative Fuel Sources,” US Patent Application, Pub. No. US 2007/0012041 A1.
Lentz, A. and Almanza, R. (2005) “Solar-geothermal hybrid system,” Applied Thermal Engineering, 26, pp. 1537-1544.
Licari, J., Ottesen, H., and Walters, J. (2006) “Hybrid Geothermal and Fuel-Cell System,” US Patent Application, Pub. No. US 2006/0053794 A1.
Mehos, M., Anselmo, K., Moreno, J., Andraka, C., Rawlinson, K., Coreyu, J., and Bohn, M. (2004) “Combustion System for Hybrid Solar Fossil Fuel Receiver,” U.S. Pat. No. 6,739,136 B2.
Meksvanh, S., Whelan, R., and Swift, D. (2006) “Solar Augmented Geothermal Energy,” US Patent Application, Pub. No. US 2006/0048770 A1.
Moore, R. (1995) “Solar-Gas Combined Cycle Electrical Generation System,” U.S. Pat. No. 5,444,972.
Stultz, S. C. & Kitton, J. B. (Eds.) (1992) Steam/its generation and use, 40^{th} edition, The Babcock and Wilcox Company, Barberton, Ohio.

We claim:

1. A hybrid power plant, comprising:
(a) a first power plant which produces secondary steam of a first temperature using a renewable source of energy;
(b) a solar power plant that has an operating temperature higher than that of the first temperature; and
(c) superheating the first temperature steam to the higher temperature in the solar power plant.

2. A hybrid power plant as defined in claim 1, wherein the first power plant is selected from the list consisting of geothermal and solar power plants.

3. A hybrid power plant as defined in claim 2, wherein the first power plant is a parabolic trough solar power plant.
